(19) United States
(12) Patent Application Publication
(10) Pub. No.: US 2008/0238354 A1
(43) Pub. Date: Oct. 2, 2008

(54) Solar energy charging device for computer

(75) Inventor: Chuan-Wang Chang, Taipei Hsien (TW)

Correspondence Address: BRUCE H. TROXELL, SUITE 1404, 5205 LEESBURG PIKE, FALLS CHURCH, VA, 22041, US

(73) Assignee: KINPO ELECTRONICS, INC.

(21) Appl. No.: 11/730,015

(22) Filed: Mar. 29, 2007

(51) Int. Cl. H02J 7/00; F03G 6/00

(52) U.S. Cl. 320/101

(57) ABSTRACT

A solar energy charging device for a computer allows the computer to be combined with a simple charging circuit and a chargeable battery, use solar energy to charge the chargeable battery, provide power sufficiently provided by a solar energy battery through the chargeable battery and need not use a general battery so that the battery is unnecessary to be replaced to reduce the use amount of general batteries to conform to the environmental protection requirement.

### BACKGROUND OF THE INVENTION

1. Field of the Invention

The present invention relates to a computer, and more particularly to a computer charged by means of solar energy.

2. Description of Related Art

General market available computer products can be separated into two different kinds depending on power source thereof:

### 1. Single Power Computer

A single battery design is adopted in almost all general computers. A battery must be replaced and such kind of computer can then continue being used as long as electricity of the battery runs out. A use time of the battery depends on a battery capacity and average power consumption of the computer. A battery life time is approximately 3 to 5 years.

### 2. Dual Power Computer

A dual power computer adopts a concurrent power providing design of solar energy and battery as implied by the name.

The solar energy provides electricity when it is sunny, but a battery must be used to provide electricity if sunshine is weak or light source is insufficient. Besides, the power of the battery can be also used when the electricity consumption of the computer itself increases and exceeds the maximum consumed current that the solar energy source can output in the time. Such kind of design manner allows the use life of the battery to be approximately 6 to 8 years. Taiwan patent publication No. 55,630 discloses a computer provided with both solar energy charger and mercury battery, i.e. a dual power computer.

The current dual power computer has merits such as simple circuit, cheap price, broad popularity and less needed electricity. But it is lack of the charging function so that a battery still needs to be replaced.

General charging circuits respectively have following various characters depending on product differences:
1. outer charging circuit, such as a solar energy power charging circuit or charging circuit of solar energy street lamp
   (1) received solar energy is strong so that larger power can be generated;
   (2) the volume of a energy storage facility is big;
   (3) the volume of a solar energy transferring panel is big; and
   (4) power needed for a facility is much.
2. portable charging apparatus, such as a charging circuit of a cellular phone or a charging circuit of a toy:
   (1) charging energy is not solar energy;
   (2) charging current is large;
   (3) power needed for a facility is much;
   (4) charging circuit control is complex; and
   (5) a volume of a charging battery is big, and requirements are many.

If the conventional charging circuits mentioned above are completely imitated in the current computers, this will cause the price of the computer to be very expansive, and the volume thereof to be large, and will completely wipe out the advantages such as cheap price and broad popularity held by the computer.

### SUMMARY OF THE INVENTION

For keeping the old advantages of a computer and coupling it to a simple charging circuit to allow it to be provided with a merit of battery replacement exemption, the present invention is proposed.

The main object of the present invention is to provide a solar energy charging device for a computer, allowing solar energy to be used on a computer to charge a chargeable battery thereof, apply insufficient power to a solar energy battery through the chargeable battery and use no general battery so that the general battery is unnecessary to be replaced and the use amount of the general batteries is reduced to conform to the environmental protection requirement.

Another object of the present invention is to provide a solar energy charging device for a computer, allowing solar energy to be fully used on the computer so as to save the purchasing cost of a general battery and reduce the trouble on replacing the general battery.

For attaining to the objects mentioned above, a solar energy charging device for a computer is adapted to use solar energy to charge a chargeable battery inside a computer, it comprises:
a chargeable battery;
a solar energy battery, used for receiving solar energy and converting it to be electric energy to output, in which the electric energy output is changed depending on environmental brightness; a voltage of the electric energy output is higher than a voltage of the chargeable battery in brighter environment.
a switch element, connected with the chargeable battery in series and controlled in a open or close state depending on s change of environmental brightness;
wherein the solar energy battery and the chargeable battery is constituted to be a circuit if the switch element is in an open state, the solar energy can provide electricity for the computer and charge the chargeable battery simultaneously in brighter environment, and when a voltage output of electric energy of the solar energy battery is lower than a voltage of the chargeable battery in dimmer environment, the chargeable battery then provides electricity for the computer; this allows the computer to use solar energy to charge the chargeable battery and the chargeable battery provides the computer with part of energy provide insufficiently by the solar energy battery. whereby, a general battery need not to be used so that the general battery need not to be replaced to reduce the use amount of the general batteries; this conforms to the environmental protection requirements and saves the purchasing cost of the general batteries and reduces the trouble for replacing the general battery.

### BRIEF DESCRIPTION OF THE DRAWINGS

The present invention can be more fully understood by reference to the following description and accompanying drawings, in which:

FIG. 1 is a circuit diagram, showing a circuit structure of a solar energy charging device for a computer of a first preferred embodiment according to the present invention;

FIG. 2 is a circuit diagram, showing a circuit structure of a solar energy charging device for a computer of a second preferred embodiment according to the present invention;

FIG. 3 is a circuit diagram, showing a circuit structure of a solar energy charging device for a computer of a third preferred embodiment according to the present invention;

FIG. 4 is a circuit diagram, showing a circuit structure of a solar energy charging device for a computer of a fourth preferred embodiment according to the present invention; and

FIG. 5 is a circuit diagram, showing a circuit structure of a solar energy charging device for a computer of a fifth preferred embodiment according to the present invention.

### DETAILED DESCRIPTION OF THE PREFERRED EMBODIMENTS

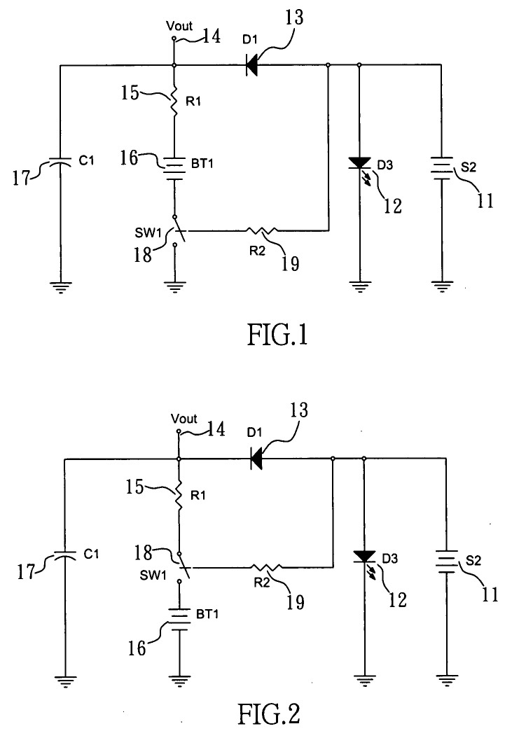

Please refer to FIG. 1. A solar energy charging device for a computer according to the present invention is adapted to use solar energy to charge a chargeable battery inside a computer, a circuit of the charging device of a first preferred embodiment comprises:
a solar energy battery 11 provided with a positive terminal and ground terminal and used for receiving solar energy and converting it to be electric energy to output;
a photodiode 12, provided with a first terminal and second terminal, in which the first terminal is grounded, the second terminal is electrically connected to a positive terminal of the solar energy battery 11 and used for stabilizing the voltage of the solar energy battery 11 to prevent the solar energy battery 11 from yielding too high a voltage to damage other electronic elements under the illumination of strong light;
a diode 13, provided with a first terminal and a second terminal, in which the first terminal is electrically connected to the positive terminal of the solar energy battery 11 and the second terminal is connected to a power output terminal 14 to allow a electric quantity output of the solar energy battery 11 is a single directional circuit;
a current limit resistance 15, provided with a first terminal and a second terminal, in which the first terminal is electrically connected to a power output terminal 14 and used for limiting an amperage of a current flowing from the solar energy battery 11 toward a chargeable battery 16 to prevent the current flowing toward the chargeable battery 16 from being too large to damage the chargeable battery 16;
the chargeable battery 16, provided with a positive terminal and a ground terminal, in which the positive terminal is electrically connected to the second terminal of the current limit resistance 15;
a capacitance 17, provided with a first terminal and a second terminal, in which the first terminal is electrically connected to the power output terminal 14, another terminal thereof is grounded and used as a power source buffer when the solar energy battery 11 and the chargeable battery 16 are switched;
a switch element 18, provided with at least two terminals, in which a first terminal thereof is electrically connected to the ground terminal of the chargeable battery 16 and a second terminal thereof is grounded; the switch element 18 is controlled to be in an open state or close state according to environmental brightness change; and
a resistance 19, provided with a first terminal and a second terminal, in which the first terminal is electrically connected to the positive terminal of the solar energy battery 11 and the second terminal is electrically connected to a third terminal of the switch element 18;
wherein, the power output terminal 14 is used for electrically connecting to a main system of the computer,; when the solar energy battery 11 is in a brighter environment, for example, brightness beyond 200 lux, and generates a larger power, output power thereof can provide power needed for the main system of the computer through the power output terminal 14 and outputs power to the third terminal to the switch element 18 through the resistance 19 to allow the third terminal is at a high potential to cause the first and the second terminals thereof to be communicated to be in an open state to enable the ground terminal of the chargeable battery 16 to be grounded via the switch element 18; the power output from the solar energy battery 11 can charge the chargeable battery 16 via the current limit resistance 15; when the solar energy battery 11 is in a dimmer environment, for example, brightness below 200 lux, and the power generated from it is not enough for the main system of the computer to use, the chargeable battery 16 can output power to the main system of the computer via the current limit resistance 15 and the power output terminal 14 to provide the power needed for the main system, and to be able to prevent the chargeable battery 16 from charging the solar energy battery 11 reversely through the diode 13. When the solar energy battery 11 is in a dark environment and in a close state that the first terminal and the second terminal of the switch element 18 are not electrically communicated, the ground terminal of the chargeable battery 16 is caused to be unable to be grounded through the switch element 18 and constitute a circuit with the main system of the computer or the solar energy battery 11, i.e. an electric circuit cannot be formed, to prevent the chargeable battery 16 from discharging excessively.

Please refer to FIG. 2. Other structures of a solar energy charging device for a computer of a second preferred embodiment according to the present invention are almost the same as the ones of the first preferred embodiment mentioned above and have the same effects as the ones thereof except an integral structure of the chargeable battery 16 and the switch element 18, i.e. a structure that the send terminal of the current limit resistance is electrically connected to the first terminal of the first terminal of the switch element 18, the second terminal of the switch element 18 is electrically connected to the first terminal of the chargeable battery 16 and the second terminal of the chargeable battery 16 is grounded.

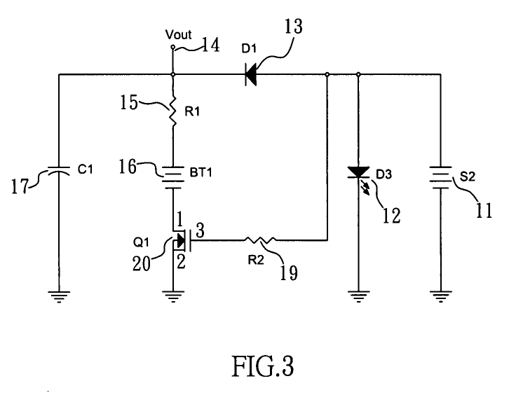

The switch element of the first or the second preferred embodiments according to the present invention can be a transistor switch circuit, MOS transistor switch circuit or anything else. As FIG. 3 shows, a switch element 20 of a solar energy charging device for a computer of a third preferred embodiment according to the present invention is a MOS transistor switch circuit. When there is sunshine on the solar energy battery 11, the solar energy battery 11 outputs power to a third terminal of the switch element 20 via the resistance 19 to allow the third terminal to be at a high potential to cause second and third terminals to be communicated with each other; the switch element 20 is in an open state to allow the ground terminal of the chargeable battery 16 to be grounded through the switch element 20 so as to be provided with a function capable of being charged or outputting power. When the solar energy battery 11 is in complete darkness, it is then unable to output power to the third terminal of the switch element 20 to cause the first and second terminals not to be communicated with each other; the switch element 20 is in a close state to cause the ground terminal of the chargeable battery 16 to be unable to be grounded via the switch element 20 to form an electric circuit so as not to be provided with a function capable of being charged or outputting power.

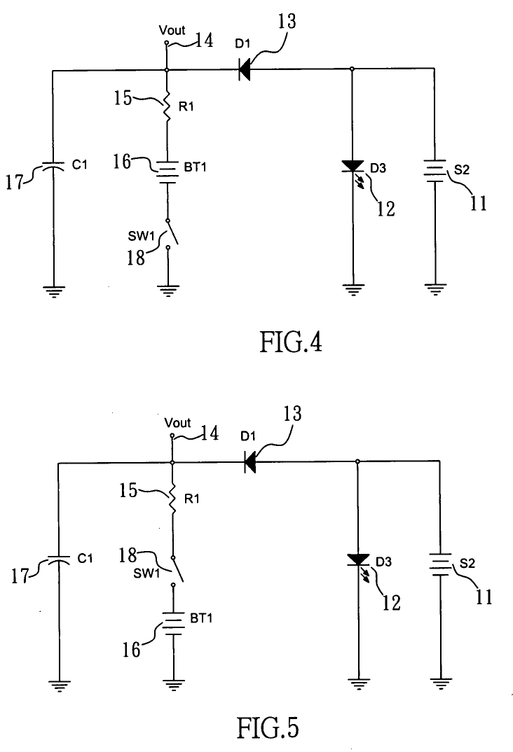

Please refer to FIGS. 4 and 5. Each structure of solar energy charging devices for a computer of fourth and fifth embodiments according to the present invention respectively approximately is the same as the ones of the first and the second embodiments, but the switch elements 18 of the fourth and the fifth embodiments are respective an optical coupler. When it is bright, the first and the second terminals of the switch element 18 are then communicated with each other in a open state; when it is dark, the first and the second terminals thereof are not communicated with each other in a close state so that it need not to provide a voltage for controlling the switch element 18 through the second terminal of the resistance 19 shown in FIGS. 1 and 2. Therefore, there is unnecessary for the disposition of the resistance 19 to simplify the circuit structure as FIGS. 4 and 5 show.

A computer according to the present invention is different from the conventional single power or dual power computer mentioned above, a battery is completely unnecessary to be replaced and a user can continually use the computer until other components thereof are deteriorated naturally, they might last 20 years or longer. When the computer is under the light illumination, it can use not only a solar energy battery to maintain the power of the computer itself, but also extra electric energy to charge a chargeable battery. But, when the power consumption of the computer itself increases and exceeds the maximum power consumption that the solar energy battery can output at that time or when it is located in weak light, the power of the chargeable battery is then used. But, if it is located back to be in normal light, the chargeable battery will continue charging the chargeable battery again such that the chargeable battery can always keep full power to enable the user does not need to purchase a general battery again.

The present invention allows a computer to keep former advantage, combines a simple chargeable circuit and a chargeable battery to allow the computer to us solar energy to charge the chargeable battery, provides part of power insufficiently provided by the solar energy battery through the chargeable battery, need not use a general battery so that the general battery need not to be replaced, reduces use amount of general batteries to conform to the environmental protection requirements, saves the purchase cost of general batter i e sand reduces the trouble for replacing a general battery.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A solar energy charging device for a computer, adapted to use solar energy to charge a chargeable battery inside the computer, comprising:
said chargeable battery;
a solar energy battery, used for receiving solar energy, converting said solar energy to electric energy and then output said electric energy, in which said electric energy is changed depending on environmental brightness, a voltage of said electric energy output is higher than a voltage of said chargeable battery in brighter environment;
a switch element, connected to said chargeable battery in series and controlled to be in an open or close state depending on environmental brightness change;
wherein, if said switch element is in an open state, said solar energy battery and said chargeable battery are constituted to be an electric circuit, said solar energy battery provides electricity for said computer and charges said chargeable battery in a brighter environment; if a voltage of electric energy output of said solar energy battery is lower than a voltage of said chargeable battery in a dimmer environment, said chargeable battery then provides electricity for said computer.

2. The solar energy charging device according to claim 1, wherein said switch element is in a close state, said chargeable battery is allowed to be unable to form a electric circuit to prevent said chargeable battery from discharging excessively.

3. The solar energy charging device according to claim 1, wherein a diode is further installed between said solar energy battery and said chargeable battery to allow an electricity output of said solar energy battery is a single directional circuit.

4. The solar energy charging device according to claim 3, wherein a current limit resistance is further installed between said diode and said chargeable battery to prevent electricity of said solar energy battery from being output excessively to damage said chargeable battery.

5. The solar energy charging device according to claim 1, further comprising a voltage stabilizing element used for stabilizing a voltage of electricity output of said solar energy battery.

6. The solar energy charging device according to claim 1, further comprising a capacitor; said capacitor is in parallel connection with said chargeable battery and is used as a power source buffer when electric energy is switched between said solar energy battery and said chargeable battery.

7. The solar energy charging device according to claim 1, wherein said switch element is a MOS transistor switch circuit; said MOS transistor is connected in series with said solar energy battery and controlled to be in an open state or a close state depending on a voltage value of electric energy output of said solar energy battery.

8. The solar energy charging device according to claim 1, wherein said element is an optical coupler sensing environmental brightness to form an open state or a close state.

9. The solar energy charging device according to claim 1, wherein said brighter environmental brightness is brightness beyond 200 lux.

10. The solar energy charging device according to claim 1, wherein said dimmer environmental brightness is brightness below 200 lux.
